(19) United States
(12) Patent Application Publication
(10) Pub. No.: US 2014/0061027 A1
(43) Pub. Date: Mar. 6, 2014

(54) FLUID TREATMENT APPARATUS

(71) Applicants: Neil Polwart, Edinburgh (GB); Steve Barfield, Aberdeen (GB); Graham Tyrie, Edinburgh (GB)

(72) Inventors: Neil Polwart, Edinburgh (GB); Steve Barfield, Aberdeen (GB); Graham Tyrie, Edinburgh (GB)

(21) Appl. No.: 13/883,545

(22) PCT Filed: Oct. 31, 2011
(86) PCT No.: PCT/GB2011/052116

§ 371 Date: Nov. 18, 2013

(30) Foreign Application Priority Data
Nov. 3, 2010 (GB) 1018555.1

(51) Int. Cl. B01J 19/12; B01D 53/86; C02F 1/32

(52) U.S. Cl. CPC B01J 19/123; C02F 1/325; C02F 1/32; B01D 53/86
USPC 204/158.2; 210/205; 210/748.1; 210/745; 422/121; 422/186.3

(57) ABSTRACT

A fluid treatment apparatus comprising: a reactor vessel defining a chamber and having an inlet and an outlet to allow fluid to flow through the chamber; a UV light source adapted to transmit light within the chamber; and a plurality of catalyst members comprising a catalytic outer surface, the catalyst members being freely contained within the chamber, wherein the apparatus is adapted to cause the catalyst members to move around within the chamber as fluid flows through the chamber.

### CLAIM OF PRIORITY

This application is a U.S. national stage filing under 35 U.S.C. 371 of International Application No. PCT/GB2011/052116 filed Oct. 31, 2011 entitled “Fluid Treatment Apparatus” which claims priority to Great Britain Application No. 1018555.1 filed Nov. 3, 2010 entitled “Fluid Treatment Apparatus”, each of which is hereby incorporated by reference herein in its entirety.

### BACKGROUND

The present invention relates to an improved advanced oxidation process for treating a fluid. In particular, but not exclusively, the invention relates to an apparatus and method to provide improved performance or synergy between UV light and the catalyst in a photocatalytic process.

It is known to use a photocatalytic process for treating a fluid. The catalyst, such as titanium dioxide, is activated by UV light to create reactive oxygen species, such as hydroxyl radicals, from water. Depending on the reactor arrangement, the catalyst and UV light can provide a synergistic effect. One type of known reactor comprises a cylindrical vessel having a UV light source located at its longitudinal axis which defines an annular chamber around the light source. This chamber is typically packed with solid beads having a catalytic coating. Therefore, the ratio of the volume of beads to the volume of the chamber is high, such as greater than 90%. A filter device typically prevents the beads from exiting the chamber due to fluid flow through the chamber. There is substantially no movement of the beads due to the presence of the filter device and also because the close packing of the beads causes them to restrain each other's movement.

It has been found that the effectiveness of this arrangement is limited because the beads inhibit the UV light from penetrating the entire chamber, particularly the outer regions near the wall of the cylindrical reactor which are furthest from the UV light source. In other words, the effectiveness of the treatment decreases as the radial distance from the UV light source increases. Therefore, the synergy of the catalyst and UV light is diminished. Also, the beads packed within the chamber restrict the flow of the fluid and can cause clogging of the filter device which again restricts flow.

It is desirable to provide an improved apparatus in which the effectiveness of the treatment is consistently high in all regions of the reactor. It is desirable to provide an improved apparatus in which there is substantially no restriction to the flow of the fluid.

### SUMMARY

According to a first aspect of the present invention there is provided a fluid treatment apparatus comprising:

a reactor vessel defining a chamber and having an inlet and an outlet to allow fluid to flow through the chamber;

a UV light source adapted to transmit light within the chamber; and

a plurality of catalyst members comprising a catalytic outer surface, the catalyst members being freely contained within the chamber,

wherein the apparatus is adapted to cause the catalyst members to move around within the chamber as fluid flows through the chamber.

The reactor vessel may comprise a continuous flow reactor. The reactor vessel may be cylindrical.

The UV light source may be located within the reactor vessel and partially define the chamber. The UV light source may be located at a longitudinal axis of the reactor vessel to define an annular chamber. Alternatively, a plurality of UV light sources may be provided within the reactor vessel. The UV light source may comprise an UV lamp.

Alternatively or in addition, the UV light source may be provided at the surface of the reactor vessel. The UV light source may comprise one or more UV LEDs which are sealingly mounted at an aperture provided at the surface of the reactor vessel.

The catalyst members may comprise spheres or beads. The beads may have a diameter in the range of 5 to 500μ. The beads may have a diameter in the range of 20 to 50μ. The beads may have a diameter of around 40μ. The catalyst members may be formed from the catalytic material. Alternatively, the catalyst members may be formed from another material, such as glass, and have a catalytic coating.

The ratio of the volume of catalyst members to the volume of the chamber may be in the range of 1% to 80%. The ratio of the volume of catalyst members to the volume of the chamber may be in the range of 20% to 60%. The ratio of the volume of catalyst members to the volume of the chamber may be around 40%.

The apparatus may include means for moving the catalyst members within the chamber. The apparatus may be configured such that the catalyst members are biased to move in a direction which is opposite to the fluid flow direction.

The catalyst members may be adapted to be buoyant. The catalyst members may be hollow. The apparatus may be configured such that the buoyancy of the catalyst members biases the catalyst members in a direction which is opposite to the flow direction. The reactor vessel may have an upper inlet and a lower outlet such that fluid flows downwards towards the outlet.

Alternatively or in addition, the moving means may comprise a second fluid which is passed through the chamber. The reactor vessel may include a second fluid inlet to allow the second fluid to pass through the chamber to move the catalyst members. The second inlet may be provided at a lower region of the chamber. The fluid to be treated may be water. The second fluid may comprise air. Alternatively or in addition, the second fluid may comprise ozone.

Alternatively or in addition, the moving means may comprise a flow device for varying the flow of fluid through the chamber. The flow device may be adapted to cause sequential periods of high flow and low flow through the chamber. The low flow may be zero flow. The flow device may be adapted to cause pulsations to the flow through the chamber. In some configurations the flow may be frequently reversed to create an oscillating flow.

The flow device may comprise a valve member adapted to sequentially open and at least partially close to vary the flow of fluid through the chamber. The valve member may include a timer.

Alternatively or in addition, the apparatus may include a pump for pumping the fluid through the reactor vessel. The flow device may comprise the pump which is adapted to sequentially vary its pumping rate to vary the flow of fluid through the chamber.

Alternatively or in addition, the apparatus may include one or more rotatable blade members. The blade members may be adapted such that fluid flowing through the reactor vessel causes rotation of the blade members. Alternatively, the blade members may be attached to a shaft which is rotatable using a power source. The blade members may be adapted to sequentially block and then unblock one or both of the inlet and outlet as the blade members rotate.

Alternatively or in addition, the flow device may comprise a siphon device provided upstream of the inlet. The siphon device may be adapted to cause interruptions to the flow of fluid to the inlet.

The apparatus may be adapted to cause turbulence within one or more regions of the chamber. The apparatus may be adapted to cause turbulence within an upper region of the chamber.

A plurality of inlets for the fluid may be provided. The inlets may be arranged to cause turbulence within the chamber near the inlet. One or more of the inlets may be arranged tangentially to the outer circumference of the chamber. One or more of the inlets may be arranged to have substantially opposing directions to cause turbulence within the chamber near the inlet.

The apparatus may include one or more baffles provided within the chamber to increase turbulence within the chamber.

The apparatus may include one or more optical sensors to measure the amount of UV light reaching the sensor. The optical sensors may be provided at the surface of the reaction chamber to measure the amount of UV light reaching the surface of the reaction chamber. The output from the optical sensors may be provided to a control unit.

The control unit may be adapted to control one or more parameters including the rate of fluid flow through the chamber, the variation of fluid flow, the degree of turbulence within the chamber and the amount of light emitted by the UV source. The control unit may be adapted to control the parameter in response to the output from the optical sensors. The control unit may be adapted to determine an optimum value of one or more parameters which corresponds to a maximum value to light measured by the optical sensors.

The inner wall of the reactor vessel may be reflective to reflect light transmitted by the UV source back into the chamber. The inner wall of the reactor vessel may include one or more discontinuities, such as corrugations.

According to a second aspect of the present invention there is provided a method of treating a fluid, the method comprising the steps of:

passing a fluid through the treatment chamber of a reactor vessel;

transmitting UV light within the chamber;

providing within the chamber a plurality of catalyst members comprising a catalytic outer surface, the catalyst members being freely contained within the chamber; and

causing the catalyst members to move around within the chamber as fluid flows through the reactor vessel.

The method may include locating the UV light source within the reactor vessel. Alternatively or in addition, the method may include providing the UV light source at the surface of the reactor vessel.

The method may include providing the catalyst members as spheres or beads having a diameter in the range of 5 to 500μ.

The method may include providing the catalyst members such that the ratio of the volume of catalyst members to the volume of the chamber may be in the range of 1% to 80%. The ratio of the volume of catalyst members to the volume of the chamber may be around 40%.

The method may include biasing the catalyst members to move in a direction which is opposite to the fluid flow direction.

Alternatively or in addition, the method may include passing a second fluid through the chamber.

Alternatively or in addition, the method may include varying the flow of fluid through the chamber so as to cause sequential periods of high flow and low flow through the chamber. The method may include causing pulsations to the flow of fluid through the chamber.

The method may include causing turbulence within one or more regions of the chamber. The method may include causing turbulence within an upper region of the chamber.

The method may include measuring the amount of UV light transmitted to a particular location. The method may include measuring the amount of UV light reaching the surface of the reaction chamber.

The method may include controlling one or more parameters in response to the measured amount of transmitted light. The parameter may include the rate of fluid flow through the chamber, the variation of fluid flow, the degree of turbulence within the chamber and the amount of light emitted by the UV source.

According to a third aspect of the present invention there is provided a fluid treatment apparatus comprising:

a reactor vessel defining a chamber and having an inlet and an outlet to allow fluid to flow through the chamber; and

a UV light source adapted to transmit light within the chamber,

wherein at least the chamber is formed from a material comprising a UV light transmitting material.

The chamber may be formed from a UV light transmitting polymer, such as a polymethylmethacrylate based polymer. Alternatively, the chamber may be formed from glass. The reactor vessel may be formed from a material comprising a UV transmitting material.

The UV light transmitting material may be selected to transmit UV light at one or more frequencies within the range of 260 to 380 nm.

The reactor vessel may be formed from a material comprising a UV light transmitting polymer. The reactor vessel may be formed using a moulding process. The reactor vessel may be moulded as two or more portions which are connectable together.

The reactor vessel may be cylindrical. The reactor vessel may be moulded as two semicircular and longitudinally extending portions which are connectable together to form the cylindrical vessel.

The chamber may have an aspect ratio defined by the ratio of the effective length of the chamber to the cross sectional area of the chamber. The aspect ratio may be greater than 10. The aspect ratio may be greater than 20. The aspect ratio may be greater than 50.

The inner surface of the chamber may comprise a catalyst. The inner surface may include a coating formed from the catalyst. The catalyst may comprise titanium dioxide.

The UV light source may be provided at the surface of the reactor vessel. The UV light source may comprise one or more UV LEDs provided at the surface of the reactor vessel. The surface of the reactor vessel may include one or more mounts for mounting the UV light source, the mounts formed during the moulding process.

The reactor vessel may be adapted to transmit UV light emitted from the UV light source through the UV light transmitting material and into the chamber. The chamber surface may be adapted to reflect UV light reaching the surface from the chamber back towards the chamber.

The external surface of the reactor vessel may be adapted to reflect UV light reaching the surface from the chamber back towards the chamber thus substantially containing all UV light within the chamber.

The reactor vessel may be adapted to cause turbulence within one or more regions of the chamber.

The reactor vessel may include one or more baffles provided within the chamber. The baffles may be adapted to increase turbulence within the chamber. One or more baffles may extend inwards from the surface of the chamber. One or more baffles may comprise an annular ring extending inwards from the surface of the chamber. One or more baffles may be adapted to extend inwards so as to occlude around 50% of the cross sectional area of the chamber.

The reactor vessel may include a plurality of baffles provided within the chamber, the baffles being longitudinally spaced from each other. The spacing between the baffles may be a multiple of the diameter or cross sectional area of the reactor, such multiple may fall in the range 0.5 to 2.

One or more baffles may include a smooth leading edge. One or more baffles may include a sharp trailing edge.

The inner wall of the reactor vessel may include one or more discontinuities, such as corrugations.

The reactor vessel may comprise a continuous flow reactor.

The reactor vessel may longitudinally reverse direction one or more times to increase the effective length of the chamber. The reactor vessel may include a serpentine chamber.

The reactor vessel may comprise a plate at least partially defining the chamber.

The fluid treatment apparatus may include a plurality of reactor vessels. The plurality of reactor vessels may be arranged in a longitudinal array. The plurality of reactor vessels may each have a profile such that they may be closely packed. When the reactor vessel comprises a plate, a plurality of plates may be provided in a stacked arrangement. Two adjacent plates may together define the chamber.

### BRIEF DESCRIPTION OF THE DRAWINGS

Embodiments of the present invention will now be described, by way of example only, with reference to the accompanying drawings in which:

FIG. 1 shows a side view of a first embodiment of a reactor vessel for treating a fluid;

FIG. 2 shows a diagrammatic side view of a chamber of the reactor vessel of FIG. 1 (a) in the absence of fluid, and (b) in operation;

FIG. 3 shows a (a) side and (b) plan view of a second embodiment of a reactor vessel for treating a fluid, the reactor vessel having a single UV light source;

FIG. 4 shows a (a) side and (b) plan view of a third embodiment of a reactor vessel for treating a fluid, the reactor vessel having multiple UV light sources; and

FIG. 5 shows a side view of a fourth embodiment of a reactor vessel for treating a fluid.

### DETAILED DESCRIPTION

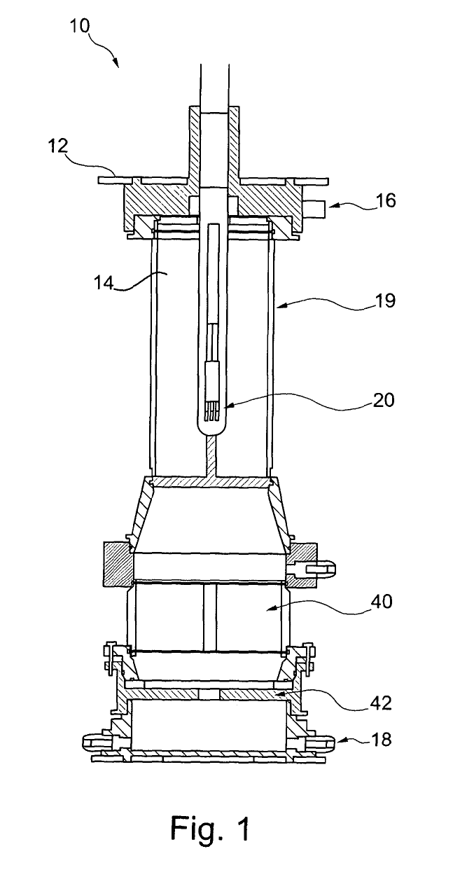

FIG. 1 shows a first embodiment of a fluid treatment apparatus 10 comprising a vertical cylindrical reactor vessel 12 and a UV lamp 20 which extends along the longitudinal axis of the reactor vessel 12. The reactor vessel 12 and UV lamp 20 define an annular treatment chamber 14. The wall 19 of the reactor vessel 12 is formed from stainless steel and the inner surface of this wall 19 is reflective to reflect light transmitted by the UV lamp 20 back into the chamber 14. Also, the inner surface of the wall 19 includes discontinuities, such as corrugations or ridges or the like, to scatter the reflected light and to provide a greater surface area for reflection.

The reactor vessel 12 has an upper inlet 16 and a lower outlet 18 to allow a continuous flow of fluid downwards through the chamber 14. A pump (not shown) pumps the fluid through the reactor vessel 12.

Although not shown, a UV light source can be provided at the surface of the reactor vessel 12. This can comprise one or more UV LEDs which are mounted at an aperture provided at various longitudinal positions at the surface 19 of the reactor vessel 12.

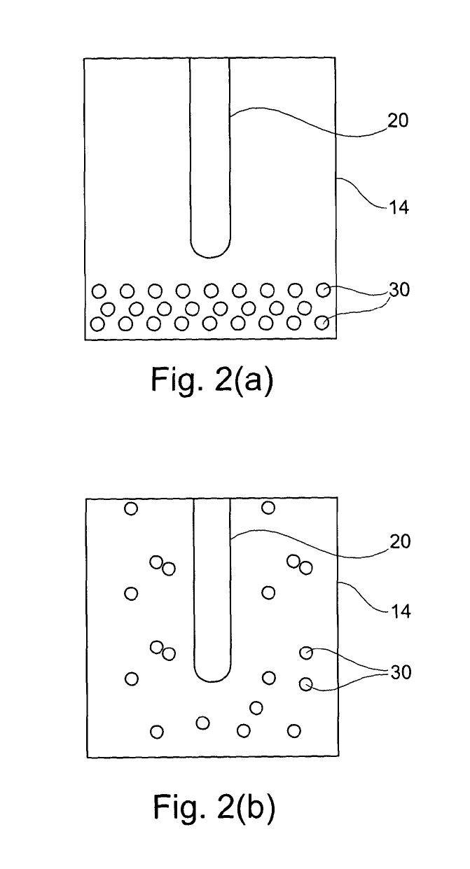

Within the chamber 14 are a number of catalyst members in the form of spherical beads 30. The beads 30 have a diameter of around 40μ and are not apparent in FIG. 1. In FIG. 1, the beads 30 have been enlarged for illustrative purposes. However, the volume taken up by the beads 30 in relation to the volume of the chamber 14 is realistic in FIG. 2.

The number of beads 30 within the chamber 14 is selected to provide a ratio of the volume of beads 30 to the volume of the chamber 14 of around 1-40%. With this ratio, the beads 30 are freely contained within the chamber in the sense that they do not substantially constrain each other from movement during fluid flow.

Each bead 30 is formed from a hollow glass sphere provided with a catalytic coating, such as titanium dioxide. The beads 30 are therefore buoyant in a fluid such as water. The UV lamp 20 and beads 30 provide a photocatalytic treatment process within the chamber 14.

The apparatus 10 includes means for moving the beads 30 so that they move around within the chamber as fluid flows through the reactor vessel 12. It has been found that this bead movement has many advantages. The movement increases mixing within the chamber 14 and also assists in scattering reflected light from the UV lamp 20. Also, the continuous movement of the beads 30 prevents them from blocking the inlet 16 or outlet 18. In addition, the lower number of beads 30 compared to conventional processes results in more light reaching further into the chamber 14 without being blocked by the beads 30. The lower number also represents less of a restriction to fluid flow. These factors result in a significant increase in the efficiency of the process.

This moving means firstly comprises the vertical configuration of the reactor vessel 12 along with the buoyancy of the beads 30. Fluid flows downwards from the inlet 16 towards the outlet 18 and will tend to carry the beads 30 along as they become entrained in the fluid flow. The buoyancy of the beads 30 biases the beads 30 in an upwards direction against the direction of flow.

In an alternative embodiment, the reactor vessel 12 can be configured for upwards fluid flow with a lower inlet and an upper outlet. The beads 30 can be formed as solid spheres having a density greater than that of the fluid so that the beads 30 are biased by gravity towards sinking to the bottom of the chamber 14 but moved upwards by the fluid flow.

The beads 30 can also be moved using a second fluid which is passed through the chamber 14, the second fluid having a different density to the fluid to be treated. For instance, the fluid to be treated may be water, and air may be introduced to a lower region of the chamber 14 at a second inlet (not shown) so that the air bubbles upwards through the chamber 14 before being collected at a top portion of the chamber 14. The air will also enhance the treatment rate due to the increased oxygen content. Rather than air, ozone can be used which itself will treat the water.

If the fluid flow through the chamber 14 is constant, the beads 30 may not sufficiently move upwards due to the constant force pushing the beads 30 downwards. To overcome this, the moving means comprises a flow device (not shown) for varying or pulsating the flow of fluid through the chamber 14. The flow device causes sequential periods of high flow and low flow through the chamber 14. During the low flow period, which may be zero or negative flow, the beads 30 will move upwards due to the buoyancy. There are various ways of achieving this.

The flow device can comprise a valve including a timer so that the valve sequentially opens and closes (or at least partially closes) to cause a pulsating flow of fluid through the chamber 14. The valve can be provided upstream or downstream of the reactor vessel 12. Alternatively the flow device could be the pump which is pumping the fluid through the reactor vessel 12. The pump can be adapted to sequentially vary its pumping rate to vary the flow of fluid through the chamber 14. Many pumps, such as rotary pumps, already produce a pulsating flow which is usually considered undesirable. Therefore, these existing pumps can be utilised without modification.

The apparatus 10 could also include rotatable blades mounted on a shaft (not shown) and located within the chamber 14. Similar to a turbine, the blades can be adapted to rotate as fluid flows through the chamber 14. Alternatively, the shaft could be rotated using a power source. The blades can be configured to sequentially block and then unblock the inlet 16 or the outlet 18 as they rotate to cause the pulsations of fluid flow.

Alternatively, the flow device could be a siphon device (not shown) provided upstream of the inlet 16 for causing interruptions to the flow of fluid to the inlet 16. Prior to entering the reactor vessel 12, the water can be fed to a holding tank mounted at a height above the reactor vessel 12. A first tube extends upwards from the base of the holding tank and, within this tube, there is smaller concentric tube which is open at the top. As the holding tank fills, the water level rises in the outer tube. When it reaches the opening to the inner open tube it is siphoned out of the tank and into the reactor vessel 12. The rate of siphoning must be higher than the input flow rate. The period of pulsing can be controlled by regulating the incoming and outgoing (siphoned) flows using valves or by the selection of tube diameters and the like. This method is particularly suited to introducing high periodic flow for moderate lengths of time (several seconds), with relatively long breaks between pulses. It also has the advantage of no moving parts.

As shown in FIG. 1, the outer diameter of the reactor vessel 12 tapers outwards to define an expansion region 40 at the lower portion of the chamber 14. Fluid flowing into this region will decelerate, assisting the entrained beads 30 to separate from the fluid. A filter 42 is provided between the expansion region 40 and the outlet 18 to prevent any beads 30 that do not separate from reaching the outlet 18. It is to be noted that the lower number of beads 30 reduces clogging of the filter 42 so there is less restriction to fluid flow.

The apparatus 10 is adapted to cause turbulence within the chamber 14. The inlet 16 is arranged tangentially to the outer circumference of the chamber 14. This creates greater turbulence and mixing near the inlet 16 where there may be a large number of beads 30 (particularly during a low flow period). In an alternative embodiment, more than one inlet 16 can be provided and these can be arranged with nozzles that direct the fluid in substantially opposing directions to cause greater turbulence.

The apparatus 10 can also include one or more baffles (not shown) within the chamber 14 to again increase turbulence within the chamber 14. Also, the fluid can be oscillated within the chamber 14 at a rate which is substantially larger than the net flow through the chamber 14 so that high levels of turbulence are achieved as it flows past the baffles.

The frequency of oscillation may be in the range 0.05 to 10 Hz, preferably in the range 0.25 to 3 Hz. The amplitude of oscillation may be in the range 1 to 100 mm, preferably in the range 10 to 50 mm. The oscillation may be sinusoidal in nature or may take on some other wave form.

Alternatively, or in addition, the oscillating perturbations can be achieved by reciprocating the baffles within the chamber 14. The movement of the fluid can also be achieved by perturbation of bellows, pistons or diaphragms connected above and below the chamber 14. The displaced volume may be in the form of a modified positive displacement pump.

Optical sensors (not shown) can be provided at the surface 19 of the reaction chamber 12 to measure the amount of UV light reaching the surface 19. The output signal from the optical sensors can be provided to a control unit. The control unit can be adapted to control a process parameter in response to the output from the optical sensors. For instance, the control unit may control the rate of fluid flow through the chamber or the variation of fluid flow (the difference between high and low flow rates or the frequency of the pulsations). Or the degree of turbulence within the chamber or the amount of light emitted by the UV lamp 20 can be controlled. Using a feedback loop, the parameters can be controlled until a maximum amount of UV light reaching the optical sensors is achieved.

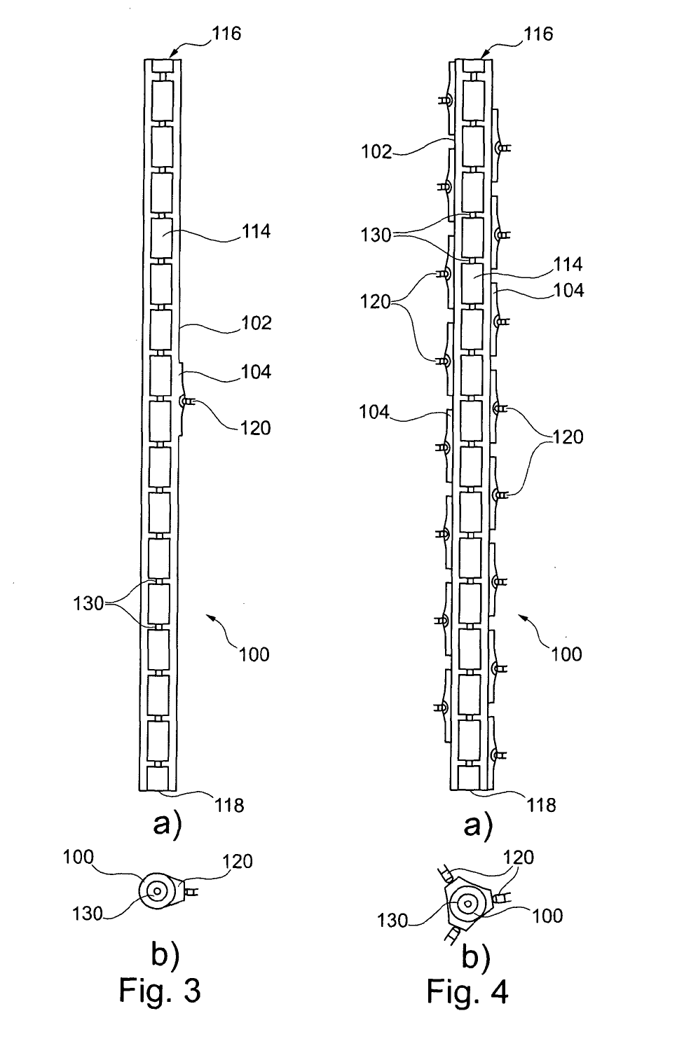

FIG. 3 shows a second embodiment of a reactor vessel 100. The reactor vessel 100 is cylindrical and defines a longitudinally extending chamber 114 fluidly connected to an inlet 116 and an outlet 118 to allow fluid to flow through the chamber 114. In this embodiment, the UV light source (in the form of a UV LED 120) is not located within the chamber 114 but rather it is provided at the exterior surface 102 of the reactor vessel 100.

The reactor vessel 100 is formed from a a UV light transmitting polymer. A polymethylmethacrylate based polymer, such as PMMA or an acrylic, may be used. The material transmits UV light within the range of 300 to 380 nm.

Substantially the entire inner surface of the chamber 114 has a coating formed from a catalyst such as titanium dioxide. In this embodiment, no other catalyst is provided within the chamber 114 (and so there is no restriction to fluid flow). However, the chamber has a high aspect ratio, which is defined by the ratio of the effective length to the cross sectional area of the chamber 114. The term “effective length” relates to the longitudinal distance that the fluid travels within the reactor vessel 100. Also, the reactor vessel 100 is adapted to cause turbulent flow as explained below. Therefore, all of the fluid contacts the catalyst provided at the inner surface of the chamber 114.

A number of baffles 130 are provided to increase turbulence within the chamber 114. Each baffle 130 comprises an annular ring which extends inwards from the surface of the chamber 114. Each of these annular rings occludes around 50% of the cross sectional area of the chamber 114. The baffles 130 are longitudinally spaced from each other by a distance which is a multiple of the diameter of the chamber 114 (in this case the multiple being approximately one). Also, each baffle may have a smooth leading edge and a sharp trailing edge. All of these features cause laminar flow within the reactor vessel 100 to be interrupted or destroyed.

Being formed from a polymer, the reactor vessel 100 can be formed using a moulding process. The reactor vessel 100 can be moulded in two halves which are fixed together, each half being semicircular in profile such that the two halves together form the cylinder. This moulding allows features such as connections for fluid lines to be readily included. Also, the surface 102 of the reactor vessel 100 can be moulded to include a mount 104 for mounting the UV LED 120.

The UV light transmitting polymer allows UV light which is emitted from the UV LED 120 located at the exterior surface 102 to be transmitted through the material and onto the interior surface 130. The material acts as a waveguide to deliver light from the single point source to multiple locations around the chamber 114. The surface 102 is also adapted to reflect UV light reaching the surface 102 from the interior surface 130 back towards the chamber 114 via total internal reflection. The reactor may contain multiple lamps colinear with the principle axis of the reactor rather just a single lamp on its principle axis.

FIG. 4 shows a third embodiment of a reactor vessel 100. This embodiment is similar to the second except that multiple UV LEDs 120 are provided at the exterior surface 102 of the reactor vessel 100.

For both the second and third embodiments, the fluid treatment apparatus can comprise a number of reactor vessels 100 which are arranged in a longitudinal array (similar to a bundle of straws). Rather than being cylindrical, each reactor vessel 100 can have a profile, such as square or hexagonal in cross section, so that they may be closely packed.

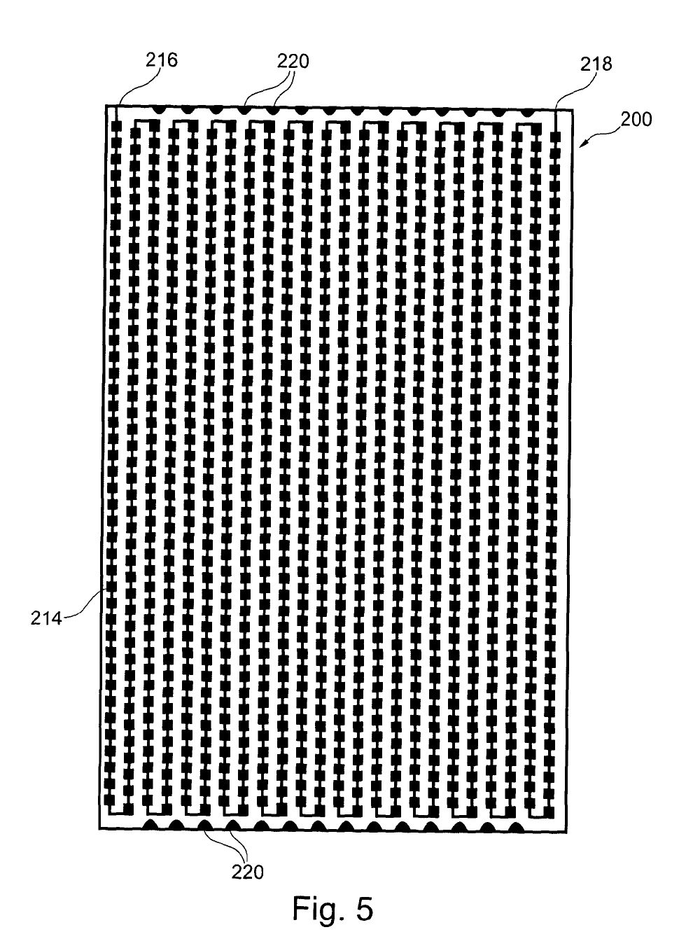

FIG. 5 shows a fourth embodiment of a reactor vessel 200. In this embodiment, the reactor vessel 200 is a flat plate having a sufficient thickness to define the chamber 214. UV LEDs 220 are located at two edges of the reactor vessel 200. Fluid flows from the inlet 216 to the outlet 118. The chamber 214 has a serpentine configuration and so the flowing fluid reverses direction many times before reaching the outlet 118. This substantially increases the effective length of the chamber.

A number of plates can be provided in a stacked arrangement. Each plate can be configured to define half of the chamber 214 such that two adjacent plates together define the chamber 214. A “half chamber” can be defined at each side of the plate.

In one or more of the embodiments, a plurality of reactors can be combined, either in parallel or in series to achieve the desired net flow and reaction residence time.

The present invention provides an improved treatment apparatus 10 in which the effectiveness of the treatment is consistently high in all regions of the reactor. Factors such as the bead movement, turbulence created and reactor wall design (such as small bore of the chamber) each contribute to achieving this consistency.

Various modifications can be made without departing from the scope of the present invention.

1. A fluid treatment apparatus comprising:
a reactor vessel defining a chamber and having at least one inlet and an outlet to allow at least one fluid to flow through the chamber;
a UV light source adapted to transmit light within the chamber; and
a plurality of buoyant catalyst members comprising a catalytic outer surface, the plurality of buoyant catalyst members being freely contained within the chamber, and
wherein the apparatus is adapted to cause the buoyant catalyst members to move around within the chamber without exiting the chamber as the at least one fluid flows through the chamber.

2. An apparatus as claimed in claim 1, wherein the reactor vessel comprises a continuous flow reactor.

3. An apparatus as claimed in claim 1, wherein the UV light source is located within the reactor vessel and at least partially defines the chamber.

4. An apparatus as claimed in claim 3, wherein the UV light source is located at a longitudinal axis of the reactor vessel to define an annular chamber.

5.-6. (canceled)

7. An apparatus as claimed in claim 1, wherein the buoyant catalyst members comprise spheres or beads.

8.-9. (canceled)

10. An apparatus as claimed in claim 1, wherein the buoyant catalyst members comprise a catalytic coating.

11.-12. (canceled)

13. An apparatus as claimed in claim 1, including a means for moving the buoyant catalyst members within the chamber.

14. An apparatus as claimed in claim 13, wherein the means for moving the buoyant catalyst members is configured to move the buoyant catalyst members in a direction which is opposite to a fluid flow direction.

15. (canceled)

16. An apparatus as claimed in claim 1, wherein a buoyancy of the buoyant catalyst members biases the buoyant catalyst members to move in a direction which is opposite to a fluid flow direction.

17. An apparatus as claimed in claim 1, wherein the at least one upper inlet is disposed to allow fluid flow downwards towards the outlet.

18.-20. (canceled)

21. An apparatus as claimed in claim 13, wherein the moving means comprises a flow device for varying a flow of fluid through the chamber.

22. An apparatus as claimed in claim 21, wherein the flow device is adapted to cause sequential periods of high flow and low flow through the chamber.

23. An apparatus as claimed in claim 22, wherein the flow device is adapted to cause pulsations to the flow through the chamber.

24. An apparatus as claimed in claim 22, wherein the flow is reversed to create an oscillating flow.

25.-30. (canceled)

31. An apparatus as claimed in claim 1, wherein the apparatus is adapted to cause turbulence within one or more regions of the chamber.

32.-42. (canceled)

43. A method of treating a fluid, the method comprising:
passing a fluid through a treatment chamber of a reactor vessel;
transmitting UV light within the treatment chamber;
providing within the treatment chamber a plurality of buoyant catalyst members comprising a catalytic outer surface, the plurality of catalyst members being freely contained within the treatment chamber; and
causing the catalyst members to move around within the treatment chamber without exiting the treatment chamber as one or more fluids flow through the reactor vessel.

44.-48. (canceled)

49. A method of claim 43, including biasing the buoyant catalyst members to move in a direction which is opposite to a fluid flow direction.

50.-51. (canceled)

52. A method of claim 43, including causing turbulence within one or more regions of the chamber.

53.-55. (canceled)

56. A method in claim 43, including controlling one or more parameters in response to a measured amount of transmitted UV light wherein the one or more parameters is one or more of the rate of fluid flow through the chamber, the variation of fluid flow, the degree of turbulence within the chamber and the amount of light emitted by the UV source.

57-82. (canceled)
